(19) United States
(12) Patent Application Publication
(10) Pub. No.: US 2025/0297440 A1
(43) Pub. Date: Sep. 25, 2025

(54) RESTORATION/PRESERVATION UNITS HAVING A PLURALITY OF OPENINGS AND USES THEREOF

(71) Applicant: The Davey Tree Expert Company, Kent, OH (US)

(72) Inventor: Frederick Worth Creech, Raleigh, NC (US)

(21) Appl. No.: 19/084,485

(22) Filed: Mar. 19, 2025

Related U.S. Application Data
(60) Provisional application No. 63/567,342, filed on Mar. 19, 2024.

(51) Int. Cl. E02B 3/06; A01K 61/73; C04B 14/28; C04B 111/00; C04B 111/74; E02B 3/04

(52) U.S. Cl. CPC E02B 3/06; A01K 61/73; C04B 14/28; E02B 3/046; C04B 2111/00017; C04B 2111/74

(57) ABSTRACT

A restoration unit for construction of eco-friendly structures in a body of water comprising a cementitious material, wherein the restoration unit is in the form of a slab having one or more openings. The restoration unit is configured such that the restoration unit can be placed on a support unit to form a restoration assembly module having a shape selected from (i) a substantially right-angled triangular prism shape with the restoration unit at an angle, wherein the ends of the substantially right-angled triangular prism shape are open or (ii) a symmetrical or asymmetrical triangle, having one side formed from the support unit and two sides formed from the restoration units, with the ends of the substantially right-angled triangular prism shape being open, wherein the restoration assembly is configured to attenuate waves.

### CROSS REFERENCE TO RELATED APPLICATIONS

The present application is related to and claims priority to U.S. Provisional Application Ser. No. 63/567,342, filed Mar. 19, 2024, pending, the contents of which are hereby incorporated by reference in their entirety.

### BACKGROUND

### Field of Invention

The present invention relates to living shorelines comprising units that are designed to stabilize a shoreline, construct revetments, and provide a place for aquatic life to thrive.

### Description of Related Art

A living shoreline is a natural approach to coastal erosion control and habitat restoration that may utilize a combination of native vegetation, sand, rocks, and other organic materials to stabilize the shoreline. Unlike traditional hard structures like seawalls or bulkheads, living shorelines work with natural processes to provide protection against erosion while also promoting biodiversity and enhancing ecosystem services. Living shorelines may provide habitat for various species of fish, birds, and other wildlife, contributing to the overall health and resilience of coastal ecosystems. These natural features also improve water quality by filtering pollutants and sediment from runoff before they reach the ocean. Furthermore, the use of living shorelines may aid in wave attenuation playing a crucial role in protecting the shoreline from erosion and mitigating the impacts of coastal storms. Overall, living shorelines offer a sustainable and environmentally friendly alternative to traditional shoreline stabilization methods, providing both ecological benefits and effective erosion control solutions.

The typical depth for deployment of a living shoreline varies based on factors like tidal range, wave energy, and local coastal conditions. Generally, living shorelines are implemented in shallow water areas, ranging from intertidal zones to shallow subtidal areas. Intertidal zones, found between high and low tidemarks, are often targeted for living shoreline projects due to their suitability for vegetation like marsh grasses and mangroves, which stabilize sediments and reduce wave energy while providing habitat, and oyster reefs Shallow subtidal areas, slightly deeper but still submerged even during low tide, can also host living shorelines with features like submerged aquatic vegetation or oyster reefs, contributing to habitat enhancement and wave attenuation. However, living shorelines in these shallow areas may be susceptible to displacement or erosion in response to high wave energy. High wave energy can exert considerable force on the vegetation and substrate of living shorelines, potentially causing erosion or displacement, especially if the vegetation and substrate are not well suited to withstand local wave conditions or if they are inadequately anchored or stabilized. Many living shoreline installations require regular monitoring and maintenance essential to mitigate the risk of displacement and ensure their long-term stability in protecting coastal areas from erosion and promoting habitat restoration.

### SUMMARY

One object of the present invention is to provide an economical solution to construct revetments, artificial reefs, shore stabilization, and other semi-aquatic ecological restoration constructions.

A further object of the present invention is to provide a composition for the restoration units, the composition preferably using locally sourced materials and some natural materials.

Another object of the present invention is to provide a method for making the restoration units of various sizes according to their construction requirements.

An additional object of the present invention is to provide a material that has the advantages of oyster shell and marl with the density of quarried rock like granite and non-calcium carbonate concrete.

A further object of the present invention to provide a customizable material using various blends of oyster shell, marl, and calcium carbonate concrete to meet the specific requirements and needs in different habitats and use cases.

Another object of the present invention is to provide a structure for wave attenuation.

These and other objects and advantages of the invention, either alone or in combinations thereof, may be satisfied by a plurality of structural units for construction of eco-friendly structures in a body of water comprising:
a) a cementitious material, preferably a cementitious material comprising a primarily calcium carbonate material; and
b) a cement that is capable of holding the primarily calcium carbonate material; wherein the restoration unit is in the form of a slab having one or more openings, wherein the restoration unit is configured such that the restoration unit can be placed on a support unit to form a restoration assembly module, wherein the restoration assembly module has a shape selected from (i) a substantially right-angled triangular prism shape with the restoration unit at an angle, wherein the ends of the substantially right-angled triangular prism shape are open or (ii) a symmetrical or asymmetrical triangular prism shape, having one side formed from the support unit and two sides formed from the restoration units, wherein the ends of the symmetrical or asymmetrical triangular prism shape are open, wherein the restoration assembly module is configured to attenuate waves.

The foregoing and other features of the application are described below with reference to the drawings.

### BRIEF DESCRIPTION OF THE DRAWINGS

FIG. 1A shows an embodiment depicting a restoration unit.

FIG. 1B shows an embodiment depicting a support unit.

FIG. 2 shows an embodiment depicting a restoration assembly module.

FIG. 3A shows a perspective view of an embodiment of a paired restoration assembly structure.

FIG. 3B shows a front view of the embodiment of a paired restoration assembly structure.

FIG. 4 shows a side view of the embodiment of a paired restoration assembly structure.

FIG. 5 shows an embodiment of an unpaired restoration assembly structure.

FIG. 6A shows a top perspective view of another embodiment of a restoration assembly structure.

FIG. 6B shows a side view of an embodiment of a restoration assembly structure.

FIG. 6C shows an exploded view of an embodiment of a restoration assembly structure.

FIG. 7A shows a top perspective view of another embodiment of a restoration assembly structure.

FIG. 7B shows a side view of an embodiment of a restoration assembly structure.

FIG. 7C shows an exploded view of an embodiment of a restoration assembly structure.

FIG. 8A shows a top perspective view of another embodiment of a restoration assembly structure.

FIG. 8B shows a side view of an embodiment of a restoration assembly structure.

FIG. 8C shows an exploded view of an embodiment of a restoration assembly structure.

FIG. 9 shows a flowchart depicting a method of making the restoration unit or support unit.

FIG. 10 shows a flowchart depicting another method of making the restoration unit or support unit.

### DETAILED DESCRIPTION

The terms “about” and “essentially” mean ±10 percent.

The terms “a” or “an,” as used herein, are defined as one or as more than one. The term “plurality,” as used herein, is defined as two or as more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments,” “an embodiment”, “an implementation” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

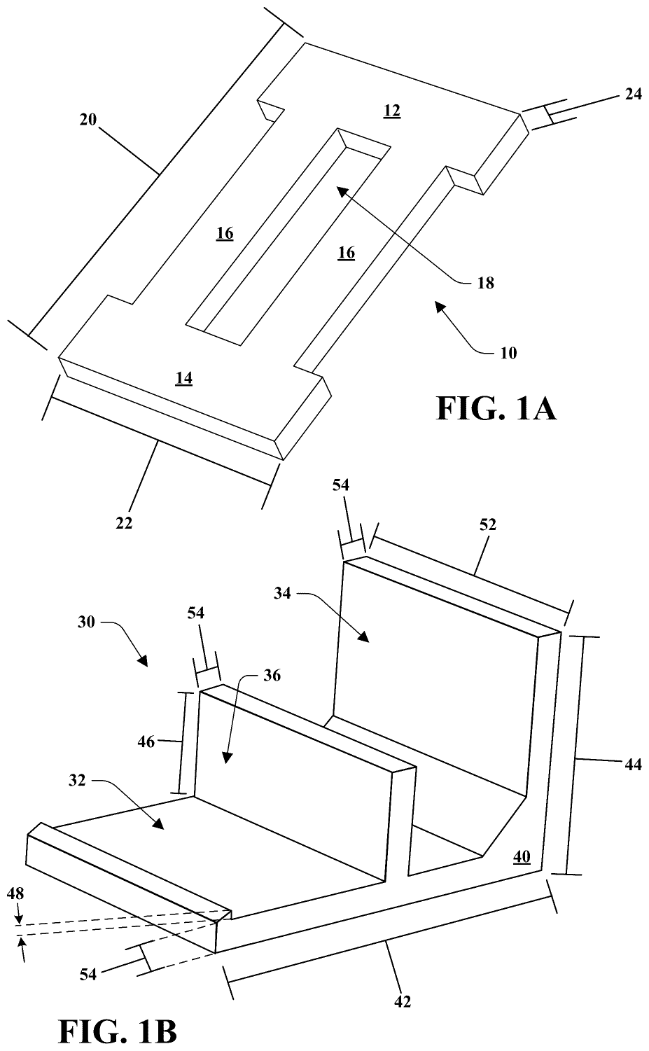

As used herein, the term “restoration unit” (10) refers to a solid piece of a cementitious material. As used herein, the term “cementitious material” includes a variety of materials, such as cement, concrete, fiber cement, and other suitably rigid cement containing materials. Preferably the cementitious material is eco-friendly to enable the attachment of wildlife, such as oysters and other sea based animals. In certain embodiments of the present invention, the cementitious material comprises a plurality of primarily calcium carbonate material held together with cement and in one embodiment, with a bio-cement. FIG. 1A shows one embodiment, in which the restoration unit (10) has a top cross piece (12), a bottom cross piece (14), and internal support pieces (16) connecting the top (12) and bottom cross pieces (14), where the internal support pieces (16) and top (12) and bottom cross pieces (14) define an opening (18), resulting in a shape like a Roman numeral two, though any shape is contemplated, with the possibility of more or fewer internal support pieces (16). While the restoration units (10) can be any size, the smallest practical restoration unit will be about four feet in length (20) and the largest may be about 25 feet in length (20). The restoration unit (10) may have a width (22) ranging from one foot to six feet, preferably one foot to three feet. The restoration unit (1) may have a thickness (24) from 1.5 inches to 6 inches. The restoration unit may have a weight from 500 to 6000 pounds. The restoration unit (10) may have an opening (18) configured to attenuate waves. The opening (18) may also allow for aquatic life such as marine invertebrate and fish species to navigate through. Furthermore, the restoration unit (10) may be shaped such that two restoration units (10) side by side meet to form an additional opening (26). In other embodiments, the restoration unit (10) may have a plurality of openings (26A, 26B, 26C . . . ), such that multiple Roman numeral two shaped units are constructed together side-by-side as a unitary body.

As used herein, the term “support unit” (30) refers to a solid piece of cementitious material. In certain embodiments of the present invention, the cementitious material comprises a plurality of primarily calcium carbonate material held together with cement and in one embodiment, with a bio-cement. FIG. 1B shows one embodiment, in which the support unit (30) may be comprised of components: a base (32), a back (34), a central support (36), and an edge support (38), such that the base (32) and the back (34) form a substantially right-angle. The support units (30) without the central support (36) may have sides (40) that form an L shape. The support units (30) with the central support (36) may have sides (40) that form an F shape. However, any shape is contemplated. While the support units (30) can be any size, the smallest practical support unit's base (32) may have a length (42) of 3.5 feet and the back (34) may have a height (44) of 1.5 feet. The largest practical support unit's base (32) may have a length (42) of 21 feet and the back (34) may have a height (44) of 12 feet. The support unit's ratio of height (44) to length (42) may be approximately 7:12. The support unit (30) may have a width (52) ranging from one foot to three feet. The central support (36) may have a height (46) less than the height of the support unit's height (44). The central support (36) may be positioned anywhere along the length (42) of the base (32), preferably at a mid-point along the base's length (42). The edge support (38) may be positioned along the width (52) of the support unit's base (32) and may have a height (48) varying from one inch to four inches. The components of the support unit (30) may have varying thicknesses (54) from 1.5 inches to 6 inches. The support unit (30) may have a weight from 1000 to 12,000 pounds.

As used herein, the term “primarily calcium carbonate material” refers to rocks, clays, minerals, and, in certain embodiments, once living material from a living organism that produces portions of the organism that are primarily made up of calcium carbonate. Examples are limestone, marble, chalk, marl sand, marl aggregate, bird eggshells, and aquatic products. Included in aquatic products and aquatic shells are oysters, seashells, snail shells, pearls, coral, tufa, and the like. A collection of these materials is treated with cement in a mold to produce the desired shape, once the cement dries.

As used herein, the term “cement” refers to any biocompatible material, which can be used in certain embodiments as the cementitious material forming the restoration assembly module or its components, and preferably in certain embodiments to hold the primarily calcium carbonate material together in a slab form and be resistant to wave action, storms, and the like. An example includes, but is not limited to, portland cement. In one embodiment, the cement is a bio-cement compatible with the primarily calcium carbonate material, which has the capability of supporting growth on the restoration units (10) or support unit (30) formation by the primarily calcium carbonate material and cement. An example includes quicklime made from oyster shells.

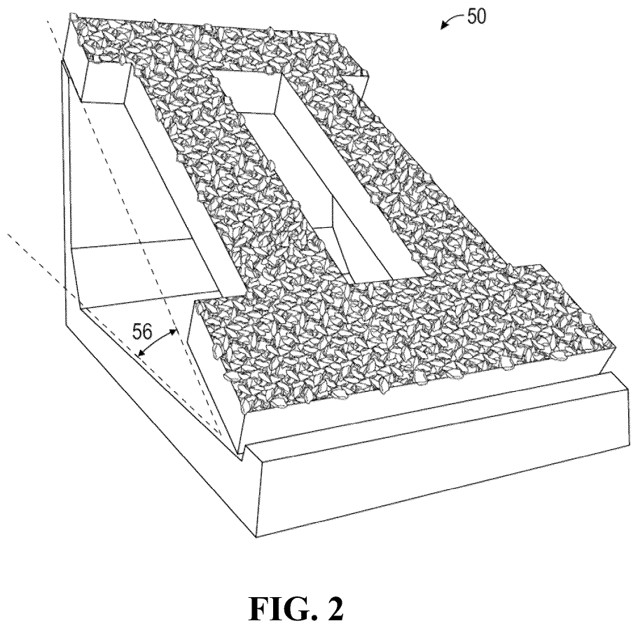

The restoration units (10) and the support units (30) may be made of virgin materials. In preferred embodiments, the restoration units (10) and the support units (30) may be primarily made of calcium carbonate; i.e. marl sand, marl aggregate, oyster shell, and cement. The restoration units (10) and the support units (30) may attract and grow oysters. Furthermore, the material that makes up the restoration units (10) and the support units (30) may be local and native to coastal regions, thus making availability and production more efficient. This and other factors result in a better carbon footprint when constructing structures with the restoration units (10) and the support units (30). It may be appreciated that the restoration units (10) and support units (30) may be made of the same composition, however in alternative implementation the ratios of composition components may vary. The restoration units (10) and support units (30) may contain rebar or other reinforcements. It should be appreciated that FIGS. 1 and 2 are shown in a smooth pattern representing less of the primarily calcium carbonate materials in the composition. The restoration units (10) and support units (30) of the following figures may also contain primarily calcium carbonate material and are preferably textured, having more of the primarily calcium carbonate materials in implementation.

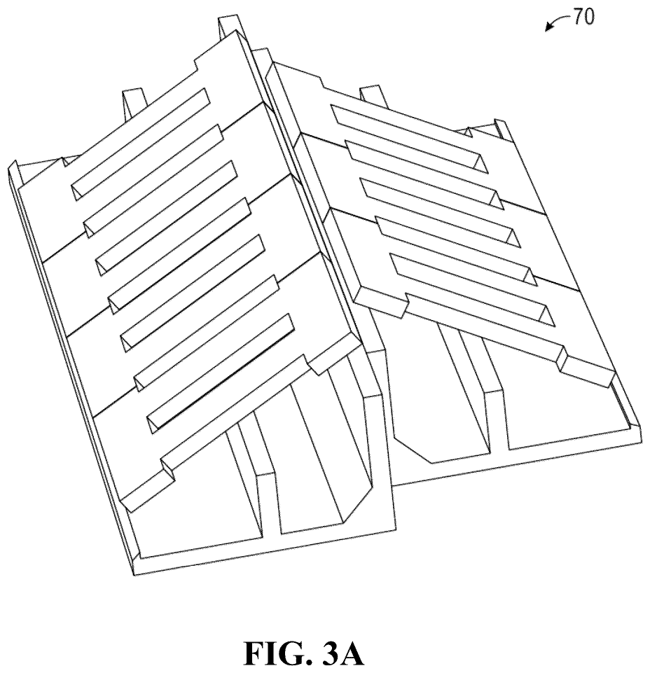

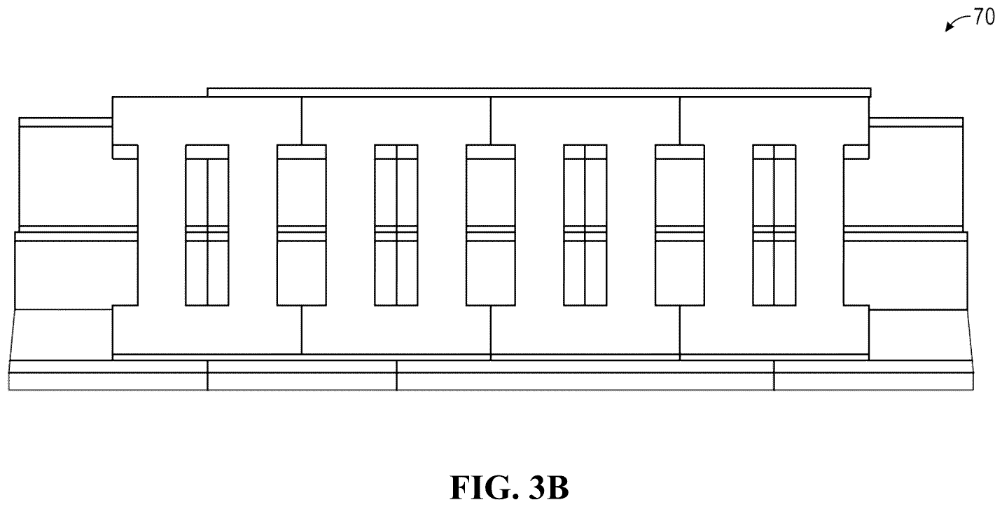

As used herein, the term “restoration assembly module” (50) refers to one restoration unit (10) placed on top of one support unit (30). FIG. 2 shows an embodiment where the restoration unit (10) and the support unit (30) form a substantially right-angled triangular prism shape, though depending on the shape of the restoration unit (10) and the support unit (30) any shape may be contemplated. The central support (36) meets the underside (28) of the restoration unit (10) (not shown in FIG. 2), and the edge support (38) provides a catch to hold the restoration unit (10) in place at an angle (56). The angle (56) may range from 30 degrees to 60 degrees measured from the support unit's base (32). In preferred embodiments, the angle (56) is set to a value such that the restoration unit (10) has a slope (rise/run) of less than or equal to 0.67. The dimensions of the restoration assembly module (50) depend on the dimensions of the restoration unit (10) and support unit (30). The structure may be scalable to meet the requirements of the installation site, determined by a person having ordinary skill in the art. FIGS. 3A, 3B, 4, and 5 show various embodiments, in which a plurality of restoration assembly modules (50) is arranged together. The restoration assembly modules (50) may have multiple openings. The openings may include but are not limited to openings through each restoration unit (18), openings formed by two restoration units side-by-side (26), openings at the ends of the restoration assembly module (58). The openings (58) at the ends of the restoration assembly module may be substantially triangular and create a channel (60) through the restoration assembly module (50). The openings (18, 26, 58) may be configured to attenuate waves, allow for flushing of water, and movement in aquatic life such as marine invertebrate and fish species. In some embodiments, oysters may have a preference to growth on the underside (28) of the restoration unit (10) due to the force of waves.

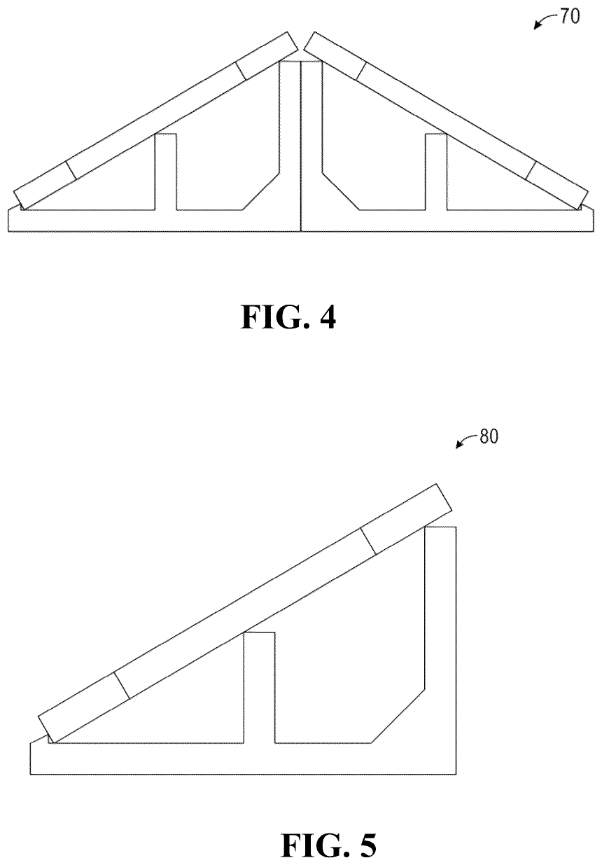

FIGS. 3 and 4 show an exemplary arrangement of restoration assembly modules (50), a paired restoration assembly structure (70). The paired restoration assembly structure (70) may have the support units (30A, 30B, 30C . . . ) positioned back-to-back (34A, 34B, 34C . . . ) and side-to-side (40A, 40B, 40C . . . ), and preferably offset like a brick pattern. The restoration units (10A, 10B, 10C . . . ) placed on top of the support units (30A, 30B, 30C . . . ) form an inverted V over the top of the paired restoration assembly structure (70). Preferably, the restoration units (10A, 10B, 10C . . . ) are positioned offset from the support units (30A, 30B, 30C . . . ) like a brick pattern. The restoration units (10A, 10B, 10C . . . ) and support units (30A, 30B, 30C . . . ) may interlock with one another enhancing the stability and cohesion of the structure (70). The resulting paired restoration assembly structure (70) may have an additional support unit (30) on each side to continue the brick pattern having each restoration unit (10) positioned across two support units (30). In one embodiment, the paired assembly structure (70) may be comprised of two restoration units (10A, 10B) and four support units (30A, 30B, 30C, 30D). In another embodiment, there may be several restoration units (10A, 10B, 10C . . . 10Nth) and support units (30A, 30B, 30C . . . 30Nth) to create a long row, potentially miles in length. The paired restoration assembly structure (70) may be applied for shoreline stabilization or form a sill. Shoreline stabilization may combat the erosion of coastal shorelines and may preferably support aquatic life. The paired restoration assembly structure (70) may form an artificial reef. The artificial reef may be constructed to enhance marine habitats or combat erosion. The paired restoration assembly structure (70) may form a sea wall. Depending on the purpose for the structure the height of the paired restoration assembly structure (70) is determined by persons having ordinary skill in the art, in some embodiments the height may be approximately 1 foot above the mean high water or less, or completely submerged. Furthermore, the paired restoration assembly structure (70) may attenuate waves in any of the above forms.

FIG. 5 shows an exemplary arrangement of restoration assembly modules, an unpaired restoration assembly structure (80). The unpaired restoration assembly structure (80) may have the support units (30A, 30B, 30C . . . ) positioned side-to-side (40A, 40B, 40C . . . ), and preferably offset like a brick pattern. The restoration units (10A, 10B, 10C . . . ) placed on top of the support units (30A, 30B, 30C . . . ) form a continuous slope with a flat back. Preferably, the restoration units are positioned offset from the support units like a brick pattern. The restoration units (10A, 10B, 10C . . . ) and support units (30A, 30B, 30C . . . ) may interlock with one another enhancing the stability and cohesion of the structure (80). The resulting unpaired restoration assembly structure (80) may have an additional support unit (30) to continue the brick pattern having each restoration unit (10) positioned across two support units (30). The unpaired restoration assembly structure (80) may form a revetment or a bulkhead. The revetment or bulkhead may be constructed to enhance marine habitats or combat erosion. The unpaired restoration assembly structure (80) may be installed around a sediment island and backfilled with more sediment to retain the island. Furthermore, the unpaired restoration assembly structure (80) may attenuate waves in any of the above forms.

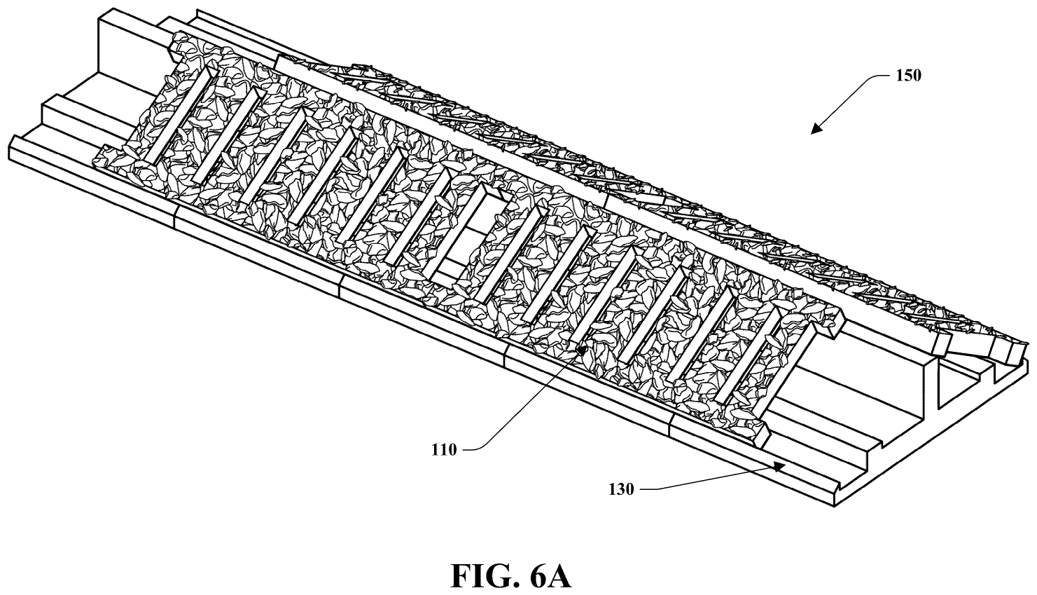

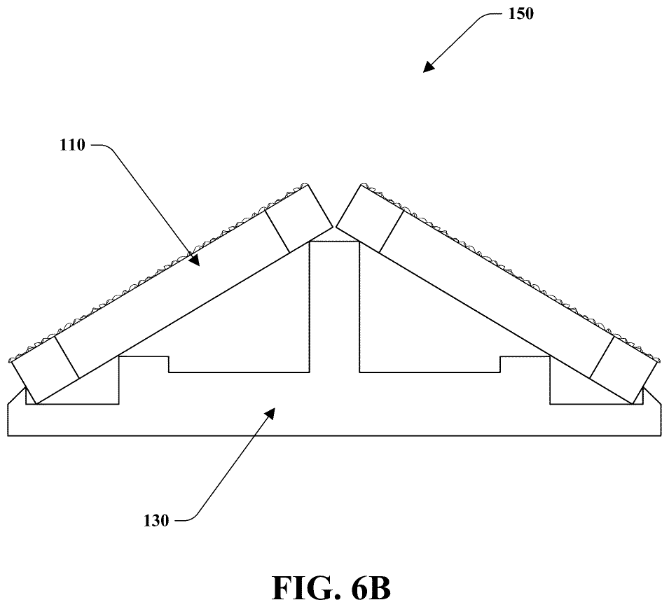

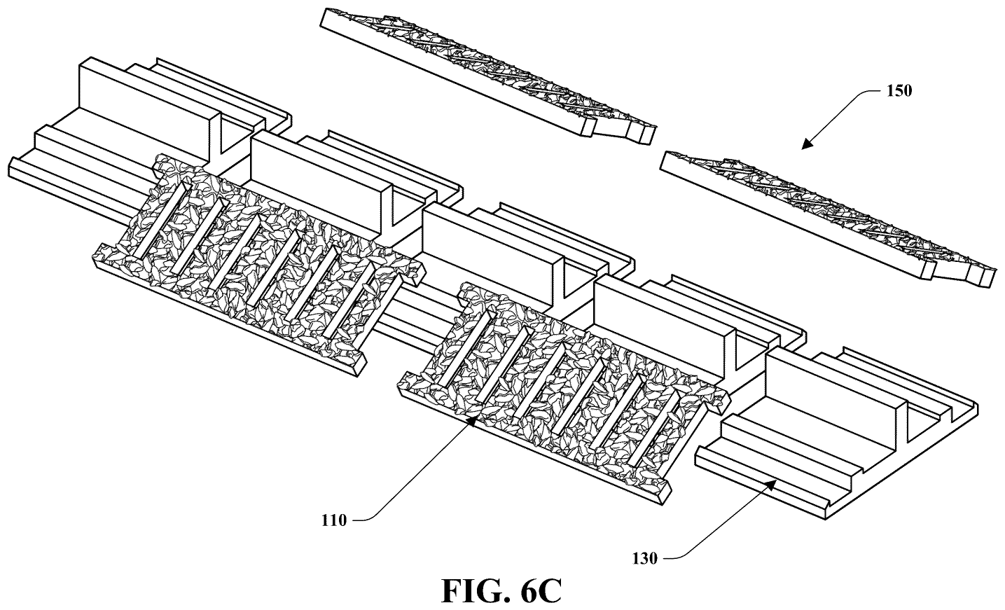

Turning now to FIGS. 6A-6C, 7A-7C, and 8A-8C exemplary embodiments of the arrangements of restoration assembly modules are shown at (150), (250), and (350), in which the restoration assembly modules (150, 250, 350) form a symmetrical or asymmetrical triangular prism shape, having one side formed from the support unit (130, 230, 330) and two sides formed from the restoration units (110, 210, 310), wherein the ends of the symmetrical or asymmetrical triangular prism shape are open. The arrangements of restoration assembly modules (150)-(350) are substantially the same as the above-referenced restoration assembly (50), and consequently the same reference numerals, but indexed by 100s-300s, are used to denote structures corresponding to similar structures in the shoes. In addition, the foregoing description of the restoration assembly (50) is equally applicable to the restoration assembly (150)-(350) except as noted below.

FIGS. 6A-6C show an exemplary arrangement of restoration assembly modules (150). The restoration unit (110) may have a plurality of openings. This exemplary arrangement of restoration assembly modules (150) may be made up of a support unit (130) constructed as a unitary piece. The back (134) central support (136) may have lesser heights (144, 146), respectively causing angle (156) to decrease. The exemplary arrangement of restoration assembly modules (150) having an overall lesser height.

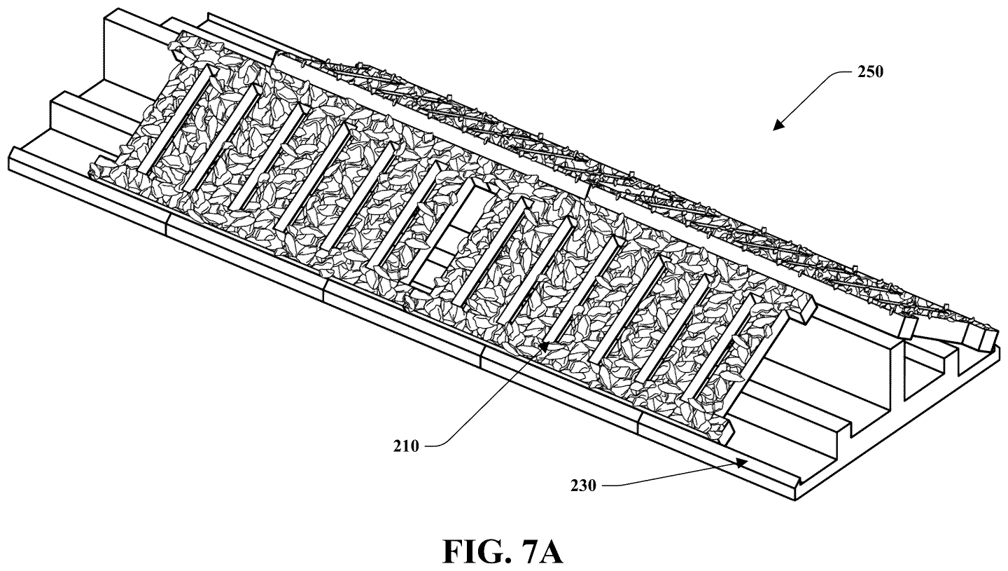

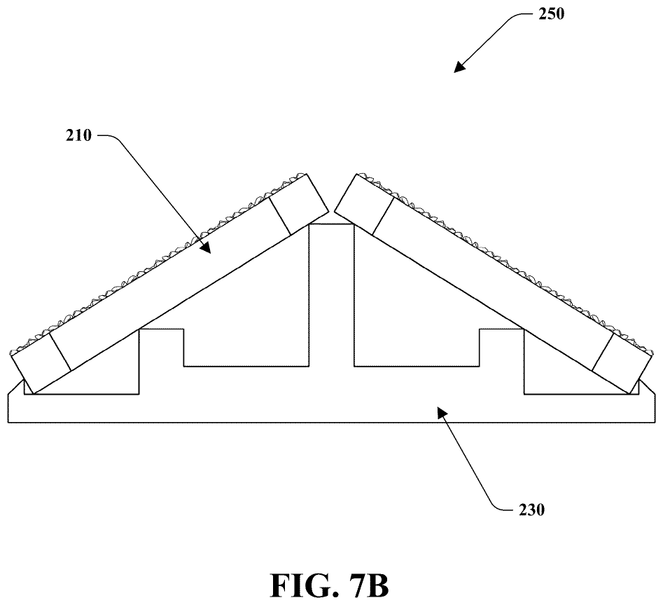

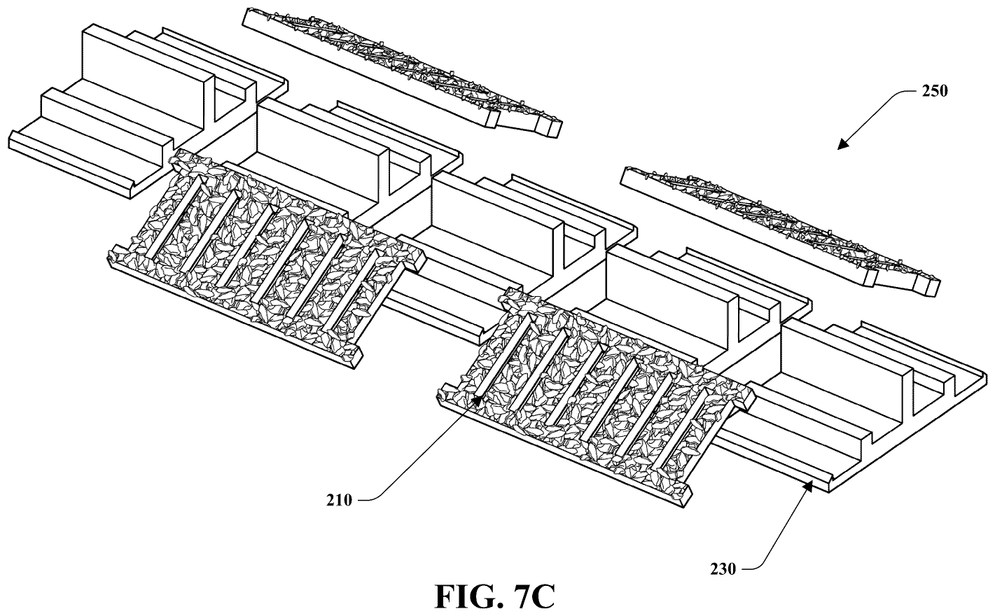

FIGS. 7A-7C show an exemplary arrangement of restoration assembly modules (250). The restoration unit (210) may have a plurality of openings. This exemplary arrangement of restoration assembly modules (250) may be made up of a support unit (230) constructed as a unitary piece. The back (234) central support (236) may have greater heights (244, 246), respectively causing angle (256) to increase. The exemplary arrangement of restoration assembly modules (150) having an overall greater height. This provides the ability to use this embodiment of restoration assembly modules (250) in greater water depths, with the greater angle (256) of the restoration unit (210) providing a narrower footprint for the greater height compared to the angle that would be required to achieve a lower angle of rise to a similar height.

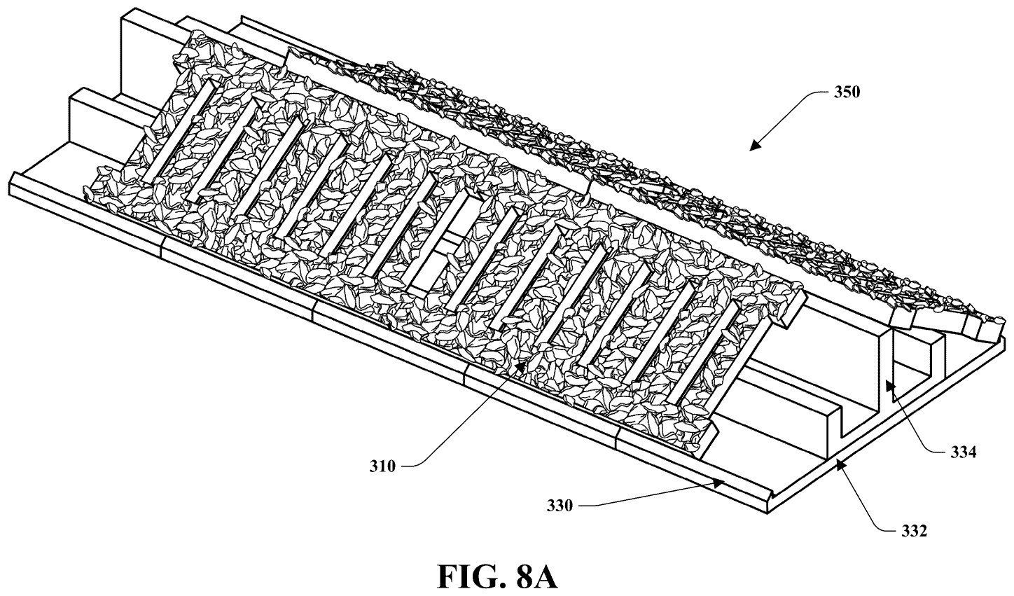

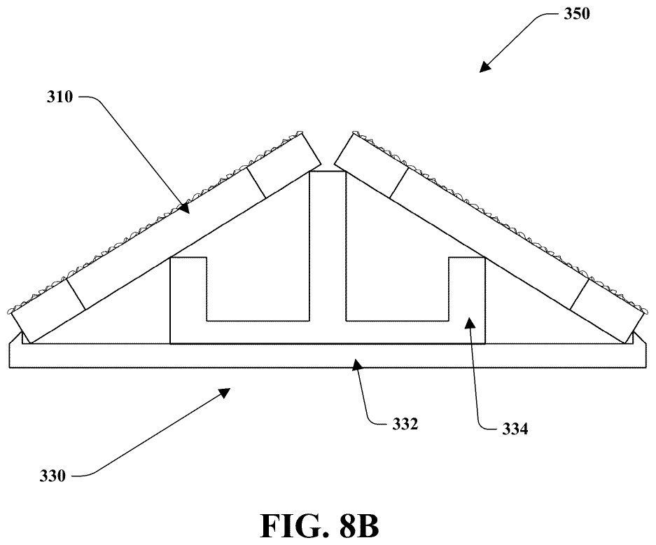

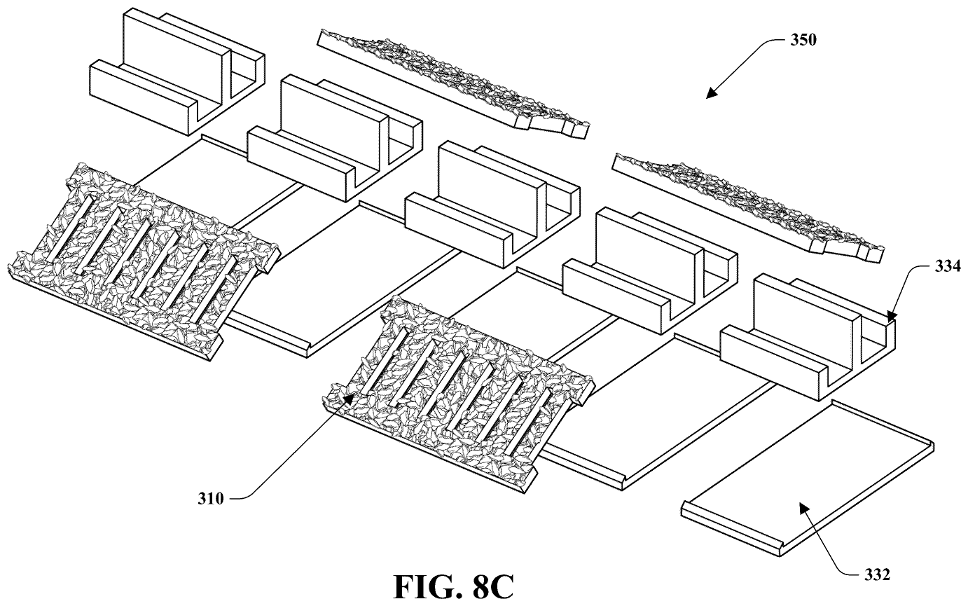

FIGS. 8A-8C show an exemplary arrangement of restoration assembly modules (350). The restoration unit (310) may have a plurality of openings. This exemplary arrangement of restoration assembly modules (350) may be made up of a support unit (330) constructed as a multiple pieces, a base (332) and a back (334). In this embodiment, the base (332) is formed as a slab with a length equal to the desired width of the restoration assembly modules (350). The back (334) is made up of three central supports (336). This embodiment provides the ability to use the same base (332) with differing backs (334) having a desired height for the water depth into which the unit will be installed. This provides greater flexibility in construction of desired structures depending on the water conditions.

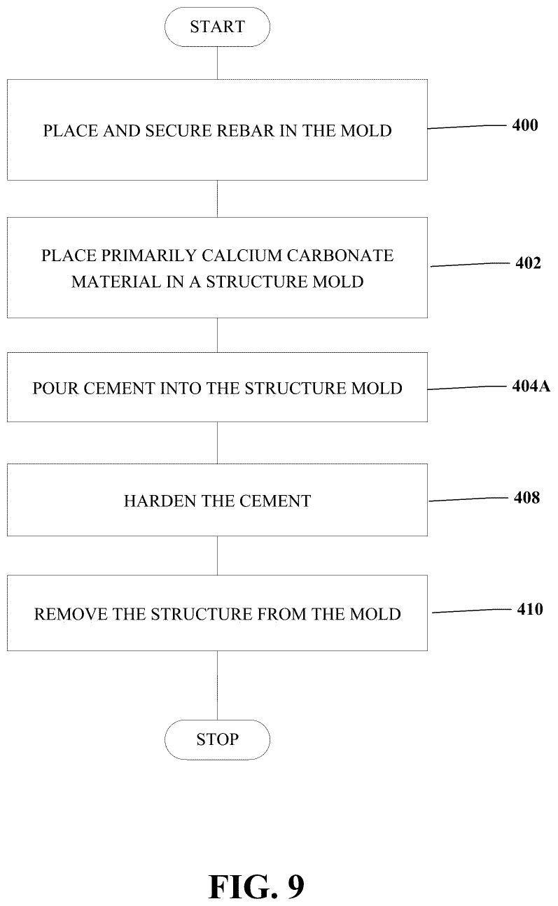

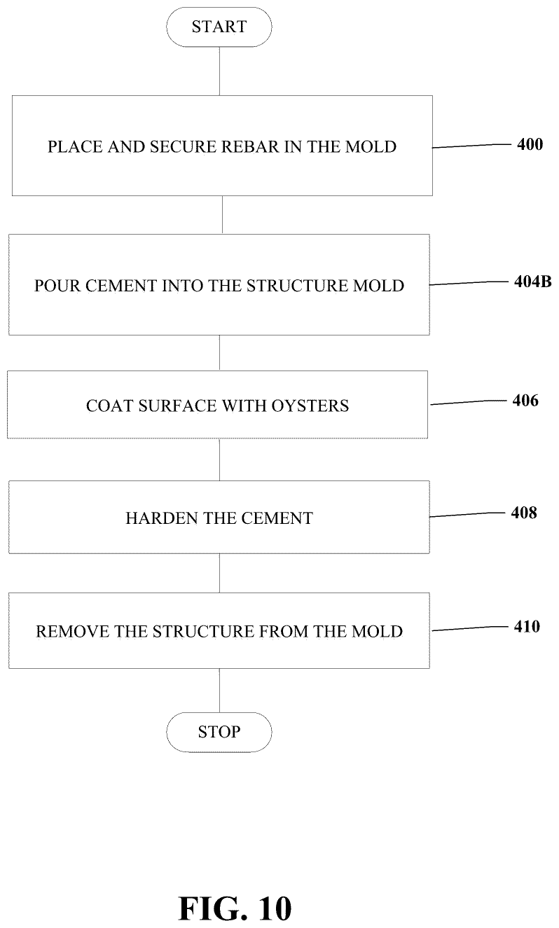

FIGS. 9 and 10 show one exemplary method of making a restoration unit (10), the support unit (30) and the resulting restoration assembly module (50), though it may be appreciated by those skilled in the art that alternative methods may be used to make the restoration unit (10), the support unit (30) or the resulting restoration assembly module (50). First, the rebar, or alternative reinforcing structure, is placed and secured in a mold (400). A plurality of primarily calcium carbonate material, such as oyster shells is placed in the mold structure (402). In an alternative embodiment, the primarily calcium carbonate material may be place in the mold first (402), then the rebar may be placed and secured in the mold (400). Next, a cement or a bio-cement is poured into the mold (404A). In an alternative embodiment, marl sand or marl aggregates may be mixed in the cement and poured in the mold structure without oyster shells (404B). In an alternative embodiment, oyster shells may be set in the cement on the outer surface to create a coating before the cement hardens to increase the texture of the restoration unit or support unit (406). When the restoration unit or support unit hardens (408), the restoration unit can be removed from the mold structure after the cement cures (410) and the restoration unit or support unit transported. In an alternative embodiment, the restoration unit and support unit may be created on site to reduce transportation costs. The restoration units and support units without oyster shells may be smooth, while the restoration units and support units with the oyster shells may have rougher jagged edges, and the restoration units and support units with an oyster shell coating will be the most jagged, or textured.

The paired restoration assembly structure and unpaired restoration assembly structure may be installed in a similar method. A designated area, which may be an intertidal zone, may be excavated and leveled as needed, removing any vegetation or organic matter that may undermine the structure's stability. The support units are placed in the desired area side-by-side, and in the installation of the paired restoration assembly structure, back-to-back. Preferably, the support units are arranged in a brick pattern. The restoration units may be placed on top of the support units in a brick pattern, confirming that the end of the restoration unit meets the edge support. The structure may be installed by hauling the restoration units and support units to the designated area by a vehicle like a car, truck, articulated hauler, or the like. The restoration units and support units may be placed in the designated area by any desired method, including but not limited to, by hand, by lifting by a crane to place in the designated area, using underwater rigging, barges or floating platforms, ballasting and de-ballasting, or the like.

The following is a non-exhaustive, non-limiting listing of embodiments of the present invention:
Embodiment 1. A restoration unit for construction of eco-friendly structures in a body of water comprising:
   a cementious material, preferably where the cementitious material is a primarily calcium carbonate material and a cement that is capable of holding the primarily calcium carbonate material;
   wherein the restoration unit is in the form of a slab having one or more openings, wherein the restoration unit is configured such that the restoration unit can be placed on a support unit to form a restoration assembly module, wherein the restoration assembly module has a shape selected from (i) a substantially right-angled triangular prism shape with the restoration unit at an angle, wherein the ends of the substantially right-angled triangular prism shape are open or (ii) a symmetrical or asymmetrical triangular prism shape, having one side formed from the support unit and two sides formed from the restoration units, wherein the ends of the symmetrical or asymmetrical triangular prism shape are open, wherein the restoration assembly module is configured to attenuate waves.
Embodiment 2. The restoration unit according to Embodiment 1, wherein the primarily calcium carbonate material is obtained from once living material from an organism.
Embodiment 3. The restoration unit according to Embodiment 1 or Embodiment 2, wherein the primarily calcium carbonate material comprises aquatic shells.
Embodiment 4. The restoration unit according to any one of Embodiments 1 to 3, wherein the cement is a bio-cement.
Embodiment 5. The restoration unit according to any one of Embodiments 1 to 4, wherein the restoration unit has a length ranging from 48 inches to 144 inches.
Embodiment 6. The restoration unit according to any one of Embodiments 1 to 5, wherein the restoration unit has a thickness ranging from 1.5 inches to 6 inches.
Embodiment 7. The restoration unit according to any one of Embodiments 1 to 6, wherein the restoration unit has a width ranging from 12 inches to 72 inches.
Embodiment 8. The restoration unit according to any one of Embodiments 1 to 7, wherein the restoration unit has a weight ranging from 500 pounds to 6000 pounds.
Embodiment 9. The restoration unit according to any one of Embodiments 1 to 8, wherein the opening has a height ranging from 12 inches to 36 inches, and a breadth ranging from 4 inches to 12 inches.
Embodiment 10. The restoration unit according to any one of Embodiments 1 to 9, wherein the support units are configured to hold each of the restoration units at an angle ranging from 30 degrees to 60 degrees.
Embodiment 11. The restoration unit according to any one of Embodiments 1 to 10, wherein the restoration assembly module has (i) the substantially right-angled triangular prism shape comprised of two substantially triangular open ends, wherein the support unit has a floor substantially perpendicular to a back, and the restoration unit is a front face that is the hypotenuse relative to the floor and the back.
Embodiment 12. The restoration unit according to Embodiment 11, wherein a paired restoration assembly structure is comprised of at least two restoration assembly modules, wherein the support units are configured back to back to hold each of the restoration units to form an inverted V shape.
Embodiment 13. The restoration unit according to Embodiment 11, wherein an unpaired restoration assembly structure is comprised of at least two restoration assembly modules, wherein the support units are configured end to end to have a channel through the unpaired restoration assembly structure.
Embodiment 14. The restoration unit according to any one of Embodiments 1 to 10, wherein the restoration assembly module has (ii) the symmetrical or asymmetrical triangular prism shape, having one side formed from the support unit and two sides formed from the restoration units, wherein the ends of the symmetrical or asymmetrical triangular prism shape are open.
Embodiment 15. A restoration assembly module, comprising:
a restoration unit according to any one of Embodiments 1 to 14; and
a support unit, wherein the support unit is configured to have a floor, a back, and a central support, such that the back and the central support extend substantially perpendicular to the floor, and each is a solid support running transversely across a length of the floor.
Embodiment 16. The restoration assembly module according to Embodiment 15, wherein the support unit is made of the same material as the restoration unit.
Embodiment 17. The restoration assembly module according to Embodiment 15 or Embodiment 16, wherein the floor has an edge support, wherein the back, the central support, and the edge support are configured to hold the restoration unit at an angle.
Embodiment 18. A method of making the restoration unit according to any one of Embodiments 1 to 14 comprising:
   a) providing a plurality of primarily calcium carbonate material;
   b) placing the primarily calcium carbonate material in a mold structure;
   c) pouring the cement into the mold in a sufficient amount that when the cement hardens the structure can be removed from the mold; and
   d) assembling the restoration unit on to a support unit,
   wherein the restoration unit is in the form of a slab having one or more openings, wherein the restoration unit is configured such that the restoration unit cab be placed on the support unit to form a restoration assembly module having a shape selected from (i) a substantially right-angled triangular prism shape with the restoration unit at an angle, wherein the ends of the substantially right-angled triangular prism shape are open or (ii) a symmetrical or asymmetrical triangular prism shape, having one side formed from the support unit and two sides formed from the restoration units, wherein the ends of the symmetrical or asymmetrical triangular prism shape are open, wherein the restoration assembly module is configured to attenuate waves.
Embodiment 19. The method according to Embodiment 18, wherein the primarily calcium carbonate material is obtained from once living material from an organism.
Embodiment 20. The method according to Embodiment 18 or Embodiment 19, wherein the primarily calcium carbonate material is aquatic shells.
Embodiment 21. The method according to any one of Embodiments 18 to 20, wherein the cement is a bio-cement.
Embodiment 22. The method according to any one of Embodiments 18 to 21, wherein the restoration unit has a length ranging from 48 inches to 144 inches.
Embodiment 23. The method according to any one of Embodiments 18 to 22, wherein the restoration unit has a thickness ranging from 1.5 inches to 6 inches.
Embodiment 24. The method according to any one of Embodiments 18 to 23, wherein the restoration unit has a width ranging from 12 inches to 72 inches.
Embodiment 25. The method according to any one of Embodiments 18 to 24, wherein restoration unit has a weight ranging from 500 pounds to 6000 pounds
Embodiment 26. The method according to any one of Embodiments 18 to 25, wherein the opening has a height ranging from 12 inches to 36 inches, and a breadth ranging from 4 inches to 12 inches.
Embodiment 27. The method according to any one of Embodiments 18 to 26, wherein the support units are configured to hold each of the restoration units at an angle ranging from 30 degrees to 60 degrees.
Embodiment 28. The method according to any one of Embodiments 18 to 27, wherein the restoration assembly module has (i) the substantially right-angled triangular prism shape comprised of two substantially triangular open ends, wherein the support unit has a floor substantially perpendicular to a back, and the restoration unit is a front face that is the hypotenuse relative to the floor and the back.
Embodiment 29. The method according to Embodiment 28, wherein a paired restoration assembly structure is comprised of at least two restoration assembly modules, wherein the support units are configured back to back to hold each of the restoration units to form an inverted V shape.
Embodiment 30. The method according to Embodiment 28, wherein an unpaired restoration assembly structure is comprised of at least two restoration assembly modules, wherein the support units are configured end to end to have a channel through the unpaired restoration assembly structure.
Embodiment 31. The method according to any one of Embodiments 18 to 27, wherein the restoration assembly module has (ii) the symmetrical or asymmetrical triangular prism shape, having one side formed from the support unit and two sides formed from the restoration units, wherein the ends of the symmetrical or asymmetrical triangular prism shape are open.
Embodiment 32. A shoreline stabilization structure formed from a plurality of restoration assembly modules according to any one of Embodiments 1 to 14.
Embodiment 33. An artificial reef structure formed from a plurality of restoration assembly modules according to any one of Embodiments 1 to 14.
Embodiment 34. A revetment structure formed from a plurality of restoration assembly modules according to any one of Embodiments 1 to 14.
Embodiment 35. A method of using the restoration unit according to any one of Embodiments 1 to 14, in making the restoration assembly module, comprising:
   a) providing a mold structure;
   b) pouring the cementitious material into the mold in a sufficient amount that when the cement hardens the structure can be removed from the mold; and
   c) assembling the restoration unit on to a support unit,
wherein the restoration unit is in the form of a slab having one or more openings,
wherein the restoration unit is configured such that the restoration unit cab be placed on the support unit to form a restoration assembly module having a shape selected from (i) a substantially right-angled triangular prism shape with the restoration unit at an angle,
wherein the ends of the substantially right-angled triangular prism shape are open or (ii) a symmetrical or asymmetrical triangular prism shape, having one side formed from the support unit and two sides formed from the restoration units, wherein the ends of the symmetrical or asymmetrical triangular prism shape are open, wherein the restoration assembly module is configured to attenuate waves.
Embodiment 36. The method according to Embodiment 35, wherein the restoration unit has a length ranging from 48 inches to 144 inches.
Embodiment 37. The method according to Embodiment 35 or Embodiment 36, wherein the restoration unit has a thickness ranging from 1.5 inches to 6 inches.
Embodiment 38. The method according to any one of Embodiments 35 to 37, wherein the restoration unit has a width ranging from 12 inches to 72 inches.
Embodiment 39. The method according to any one of Embodiments 35 to 38, wherein restoration unit has a weight ranging from 500 pounds to 6000 pounds
Embodiment 40. The method according to any one of Embodiments 35 to 39, wherein the opening has a height ranging from 12 inches to 36 inches, and a breadth ranging from 4 inches to 12 inches.
Embodiment 41. The method according to any one of Embodiments 35 to 40, wherein the support units are configured to hold each of the restoration units at an angle ranging from 30 degrees to 60 degrees.
Embodiment 42. The method according to any one of Embodiments 35 to 41, wherein the restoration assembly module having a substantially right-angled triangular prism shape is comprised of two substantially triangular open ends, the support unit has a floor substantially perpendicular to a back, and the restoration unit is a front face that is a hypotenuse relative to the floor and the back.
Embodiment 43. The method according to any one of Embodiments 35 to 42, wherein a paired restoration assembly structure is comprised of at least two restoration assembly modules, wherein the support units are configured back to back to hold each of the restoration units to form an inverted V shape.
Embodiment 44. The method according to any one of Embodiments 35 to 43, wherein an unpaired restoration assembly structure is comprised of at least two restoration assembly modules, wherein the support units are configured end to end to have a channel through the unpaired restoration assembly structure.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A restoration unit for construction of eco-friendly structures in a body of water comprising:
a) a cementitious material; a primarily calcium carbonate material; and
b) a cement that is capable of holding the primarily calcium carbonate material;
wherein the restoration unit is in the form of a slab having one or more openings, wherein the restoration unit is configured such that the restoration unit can be placed on a support unit to form a restoration assembly module, wherein the restoration assembly module has a shape selected from (i) a substantially right-angled triangular prism shape with the restoration unit at an angle, wherein the ends of the substantially right-angled triangular prism shape are open or (ii) a symmetrical or asymmetrical triangular prism shape, having one side formed from the support unit and two sides formed from the restoration units, wherein the ends of the symmetrical or asymmetrical triangular prism shape are open, wherein the restoration assembly module is configured to attenuate waves.

2. The restoration unit according to claim 1, wherein the cementitious material comprises primarily calcium carbonate material, and a cement that is capable of holding the primarily calcium carbonate material.

3. The restoration unit according to claim 2, wherein the primarily calcium carbonate material is obtained from once living material from an organism.

4. The restoration unit according to claim 2, wherein the primarily calcium carbonate material comprises aquatic shells.

5. The restoration unit according to claim 2, wherein the cement is a bio-cement.

6. The restoration unit according to claim 1, wherein the support units are configured to hold each of the restoration units at an angle ranging from 30 degrees to 60 degrees.

7. The restoration unit according to claim 1, wherein the restoration assembly module has (i) the substantially right-angled triangular prism shape comprised of two substantially triangular open ends, wherein the support unit has a floor substantially perpendicular to a back, and the restoration unit is a front face that is the hypotenuse relative to the floor and the back.

8. The restoration unit according to claim 7, wherein a paired restoration assembly structure is comprised of at least two restoration assembly modules, wherein the support units are configured back to back to hold each of the restoration units to form an inverted V shape.

9. The restoration unit according to claim 7, wherein an unpaired restoration assembly structure is comprised of at least two restoration assembly modules, wherein the support units are configured end to end to have a channel through the unpaired restoration assembly structure.

10. The restoration unit according to claim 1, wherein the restoration assembly module has (ii) the symmetrical or asymmetrical triangular prism shape, having one side formed from the support unit and two sides formed from the restoration units, wherein the ends of the symmetrical or asymmetrical triangular prism shape are open.

11. A restoration assembly module, comprising:
a restoration unit according to claim 1; and
a support unit, wherein the support unit is configured to have a floor, a back, and a central support, such that the back and the central support extend substantially perpendicular to the floor, and each is a solid support running transversely across a length of the floor.

12. The restoration assembly module according to claim 11, wherein the support unit is made of the same material as the restoration unit.

13. The restoration assembly module according to claim 11, wherein the floor has an edge support, wherein the back, the central support, and the edge support are configured to hold the restoration unit at an angle.

14. A method of making the restoration unit according to claim 1 comprising:
a) providing a plurality of primarily calcium carbonate material;
b) placing the primarily calcium carbonate material in a mold structure;
c) pouring the cement into the mold in a sufficient amount that when the cement hardens the structure can be removed from the mold; and
d) assembling the restoration unit on to a support unit,
wherein the restoration unit is in the form of a slab having one or more openings, wherein the restoration unit is configured such that the restoration unit cab be placed on the support unit to form a restoration assembly module having a shape selected from (i) a substantially right-angled triangular prism shape with the restoration unit at an angle, wherein the ends of the substantially right-angled triangular prism shape are open or (ii) a symmetrical or asymmetrical triangular prism shape, having one side formed from the support unit and two sides formed from the restoration units, wherein the ends of the symmetrical or asymmetrical triangular prism shape are open, wherein the restoration assembly module is configured to attenuate waves.

15. The method according to claim 14, wherein the primarily calcium carbonate material is obtained from once living material from an organism.

16. The method according to claim 14, wherein the primarily calcium carbonate material is aquatic shells.

17. The method according to claim 14, wherein the cement is a bio-cement.

18. The method according to claim 14, wherein the restoration assembly module has (i) the substantially right-angled triangular prism shape comprised of two substantially triangular open ends, wherein the support unit has a floor substantially perpendicular to a back, and the restoration unit is a front face that is the hypotenuse relative to the floor and the back.

19. The method according to claim 18, wherein a paired restoration assembly structure is comprised of at least two restoration assembly modules, wherein the support units are configured back to back to hold each of the restoration units to form an inverted V shape.

20. The method according to claim 18, wherein an unpaired restoration assembly structure is comprised of at least two restoration assembly modules, wherein the support units are configured end to end to have a channel through the unpaired restoration assembly structure.

21. The method according to claim 14, wherein the restoration assembly module has (ii) the symmetrical or asymmetrical triangular prism shape, having one side formed from the support unit and two sides formed from the restoration units, wherein the ends of the symmetrical or asymmetrical triangular prism shape are open.

22. A structure formed from a plurality of restoration assembly modules according to claim 1, wherein the structure is selected from a shoreline stabilization structure, an artificial reef structure, or a revetment structure.
